(19) United States
(12) Patent Application Publication
(10) Pub. No.: US 2010/0171388 A1
(43) Pub. Date: Jul. 8, 2010

(54) Pressure-Laminated Stator Ring and Method of Manufacture

(75) Inventors: Ming H. CHEN, Rancho Palos Verdes, CA (US); Chun-Yuan Wang, Taipei (TW); Yu-Tang Guan, Taipei (TW)

Correspondence Address: CLIFFORD B. PERRY, 132 N. EL CAMINO REAL, No. 347, ENCINITAS, CA, 92024-2801, US

(73) Assignee: Victory Industrial Corporation, Taipei (TW)

(21) Appl. No.: 12/642,888

(22) Filed: Dec. 21, 2009

(30) Foreign Application Priority Data
Jan. 6, 2009 (TW) 098100194

(51) Int. Cl. H02K 1/18; H02K 15/02

(52) U.S. Cl. 310/216.065; 29/596

(57) ABSTRACT

A method for manufacturing a pressure-laminated stator ring includes forming a plurality of stator ring elements, and electrically insulating each of the stator ring elements. The electrically-insulated stator ring elements are pressure-laminated together to form a multi-layered stator ring.

### BACKGROUND

The present invention relates to a stator ring, and more particularly to a pressure-laminated stator ring and processes for manufacturing same.

A stator ring, which is a major constituent component of an electric generator, is known to be formed by stacking a plurality of metallic annular stator plates and then shaping the same as a cylindrical structure by a coupling process so as to be used in field coil winding.

In general, an electric generator is manufactured according to the Faraday-Lenz Law. The Faraday-Lenz Law describes voltage induced in a field coil. In fact, a change of magnetic flux through a metallic structure always induces a voltage across the metallic structure and causes an eddy current to flow therein, thereby resulting in an eddy current loss. Referring to FIG. 6, with a stator ring being made of metal, magnetic field lines 98 passing the stator ring form a closed loop of a current 99 across a cross section perpendicular to the magnetic field lines 98, which contributes to an internal eddy current loss expressed by P=I²R, and in consequence Joule heat is generated to the detriment of overall performance.

An eddy current is an electrical phenomenon which is inevitable and yet can be minimized during its generation. Referring to FIG. 7, a conventional stator ring is formed from a stack of laminations comprising a plurality of thin plates, and the path of an eddy current is increased so as to augment the resistance to a current 99A generated by magnetic field lines 98A passing the laminations with a view to reducing an eddy current. Welding or riveting is the usual means of coupling laminations to form a stator ring of an electric generator according to the prior art, but doing so unfavorably creates a closed circuit between the laminations and increases an eddy current loss contrary to the purpose of stacking and laminating a plurality of thin plates—reduction of an eddy current loss.

In practice, the conventional way of coupling a plurality of stator plates together by welding or riveting has drawbacks as follows:

1. The stator plates are not made of a heat-resistant material. During a welding procedure whereby the stator plates are coupled together, the stator plates are likely to be damaged or partly deformed by high heat because the welding procedure is inappropriately performed. Also, the stator plates are separate from each other before being coupled together; hence, odds are the stator plates stacked and laminated by welding are not well aligned with each other. Consequently, management of the conventional stator ring process is highly challenged.

2. When performed to couple the stator plates together, a riveting procedure entails forming in each of the stator plates a plurality of through holes corresponding in position to riveting elements respectively and, upon the stacking of the stator plates, inserting the riveting elements into the through holes so as for the stator plates to be fixed in position. While the riveting procedure seldom damages the stator ring, it is time-consuming and laborious, not to mention that forming the through holes in the stator plates may deteriorate the overall quality of the stator ring and thereby decrease the output of the electric generator.

In conclusion, the conventional stator ring process suffers significant drawbacks.

### SUMMARY

To overcome the above drawbacks of the prior art, it is the objective of the present invention to provide a high-performance stator ring and manufacturing process for eliminating known drawbacks of using welding or riveting as a means of coupling and shaping a stator ring.

In one embodiment of the invention, a method for manufacturing a pressure-laminated stator ring is presented. The method includes forming a plurality of stator ring elements, and electrically insulating each of the stator ring elements. The electrically-insulated stator ring elements are pressure-laminated together to form a multi-layered stator ring.

These and other aspects of the invention will be better understood in view of the following drawings and detailed description of exemplary embodiments.

### BRIEF DESCRIPTION OF THE DRAWINGS

FIG. 1 illustrates a method for manufacturing a pressure-laminated stator ring in accordance with one embodiment of the present invention;

FIG. 2 illustrates a perspective view of stator ring elements formed in accordance with the method of FIG. 1;

FIG. 3 illustrates an exemplary embodiment of coating stator ring element with an electrically-insulating adhesive in accordance with the method of FIG. 1;

FIG. 4 illustrates bake-drying stator ring elements after each is coated with an electrically-insulating adhesive layer in accordance with FIG. 1;

FIG. 5 illustrates a plurality of stator ring elements loaded onto a pressure jig for pressure-laminating the stator ring elements together to form a multi-layered stator ring in accordance with the method of FIG. 1;

FIG. 6 is a schematic drawing illustrating an eddy current loss incurred by a stator ring of a large cross section according to the prior art;

FIG. 7 is a schematic drawing illustrating an eddy current loss incurred by a stator ring of a plate-shaped cross section according to the prior art;

FIG. 8 is a table of differences in conductive properties between a stator ring fabricated by welding according to the prior art and a stator ring fabricated according to present invention; and

FIG. 9 illustrates a pressure-laminated stator ring manufactured in accordance with the method of FIG. 1.

For clarity, previously referenced features retain their reference indices in subsequent drawings.

### DETAILED DESCRIPTION OF EXEMPLARY EMBODIMENTS

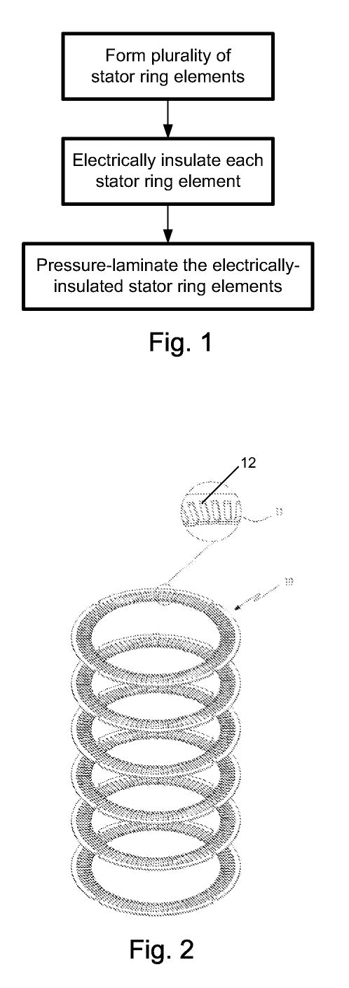

FIG. 1 illustrates an exemplary method of manufacturing a pressure-laminated stator ring in accordance with the present invention. At 102, a plurality of individual stator ring elements are formed. At 104, each stator ring element is electrically insulated. At 106, the plurality of electrically-insulated stator ring elements are pressure-laminated together to form a multi-layered stator ring.

FIG. 2 illustrates a plurality of stator ring elements 10 which have been formed in accordance with operation 102 of FIG. 1. In a particular embodiment, stator ring elements 10 are formed by punching a planar sheet of a raw material, e.g., a ferrous material, such as iron, silicon steel. Other means for fabricating the individual stator ring elements 10 may be used as well, for example laser cutting, punching, or the like.

As shown, each stator ring element 10 includes an inner rim or edge 12 from which a plurality of T-shaped talons 11 extend therefrom into the inner radius region of the stator ring element. In a particular embodiment, the talons 11 are spaced uniformly along the inner rim 12, and are operable to hold the coil and to prevent an adjacently-located coil from protruding into the inner rim.

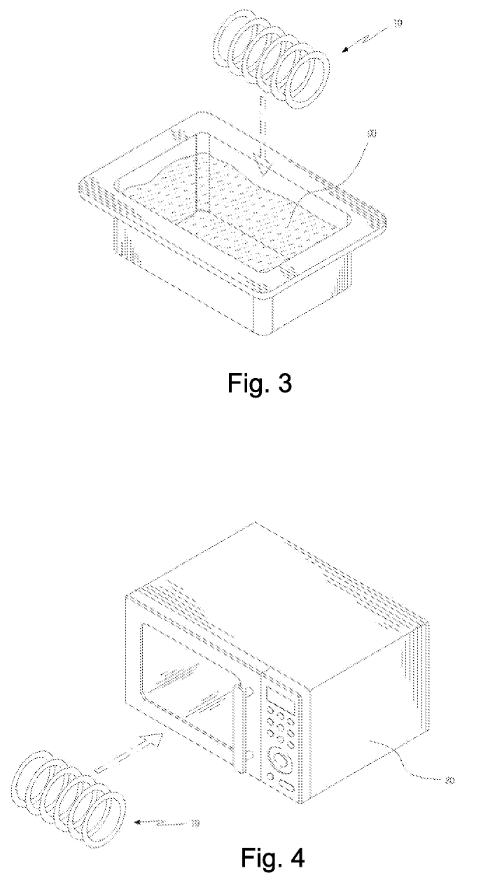

In an exemplary embodiment of operation 104, each stator ring element 10 is coated with an electrically-insulating material, for example, an electrically-insulating varnish applied to the stator ring element 10 by means of electro-deposition coating (ED). In another exemplary embodiment, operation 104 includes coating each stator ring element 10 with an electrically-insulating adhesive material 90 (e.g., a varnish, or similar material). FIGS. 3 and 4 illustrate specific operations in such a process, whereby the stator ring elements 10 are soaked or coated with the electrically insulating adhesive material 90, and subsequently drying the stator ring elements 10, for example, naturally or by bake-drying the stator ring elements 10 in an oven 80. At the conclusion of operation 104, each stator ring element 10 includes an electrically-conductive inner layer (which is formed from the electrically-conductive material of the stator ring element 10, e.g. iron or another ferrous material), and an outer electrically-insulating outer layer which substantially covers all of the electrically conductive inner layer.

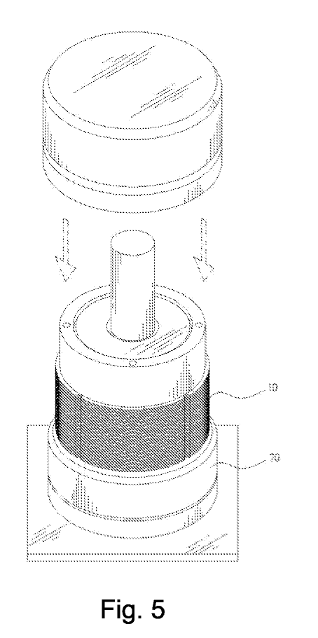

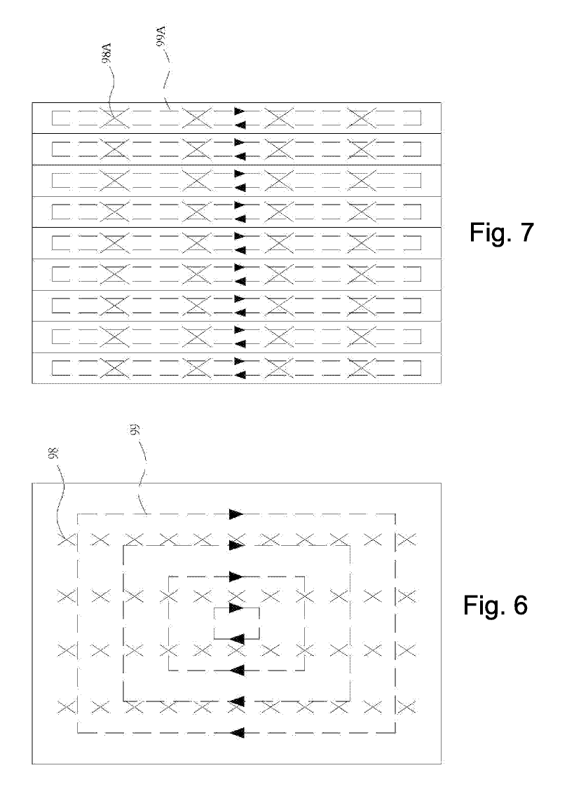

FIG. 5 illustrates a plurality of stator ring elements 10 loaded onto a pressure jig 70 for pressure-laminating the stator ring elements together to form a multi-layered stator ring in accordance with the method of FIG. 1. The pressure laminating step 106 involves stacking/inserting the stator ring elements 10 on/into a pressure jig 70 and exerting by the pressure jig 70 a stress upon a surface of the stator ring elements 10 both vertically and centripetally so as for the stator ring elements 10 to be laminated to form the improved stator ring. Application of the centripetal and vertical compression forces allows for a faster lamination process. The pressure laminating operation 106 substitutes for a welding or riveting procedure available in the existing art. Other techniques for pressure-laminating the stator ring elements 10 together to form a multi-layered stator ring may also be used.

Unlike the prior art, the present invention dispenses with welding which might otherwise cause damage or partial deformation to a stator ring or result in imprecise alignment of a plurality of plates with each other, and entails performing a pressure laminating operation so as to spare an intricate riveting procedure which involves forming a plurality of through holes in each of the plates one by one and avoid the through hole-induced deterioration of the overall quality of the finished products. The manufacturing process of the present invention entails insulating each of a plurality of stator ring elements 10 before pressure laminating the stator ring elements together to form the improved stator ring. These operations minimize eddy current generation and reduce eddy current loss because an insulating material is filled between the plates to thereby reduce the cross-sectional area of metallic portions of the cross section of the stator ring. Hence, each stator ring element 10 exhibits low conductivity when formed and laminated in accordance with the manufacturing process of the present invention instead of welding or riveting as done in the conventional methods.

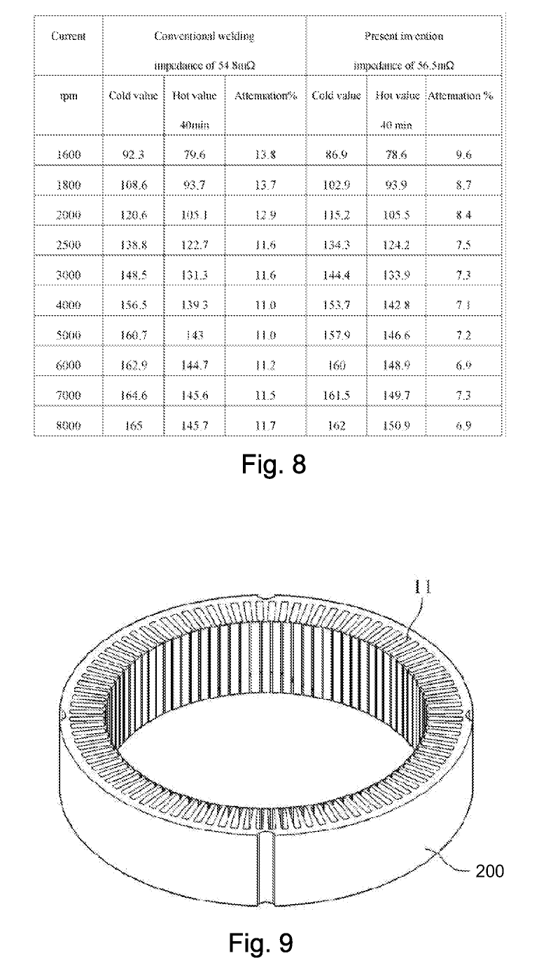

FIG. 8 illustrates a comparison of the conductive properties of a stator ring fabricated using welding per the conventional method versus the pressure laminate attachment technique used in the present invention.

FIG. 9 illustrates a pressure-laminated stator ring 200 manufactured in accordance with FIG. 1. The pressure laminated stator ring 200 includes a plurality of stator ring elements, each of which includes an electrically-conductive inner layer covered by an electrically-insulating outer layer. The number of stator ring elements included within the pressure-laminated stator ring 200 may be any arbitrary number, for example, 2, 10, 20, 40, 60, 84, 100, 150, or more. The stator ring of the present invention may be implemented in a variety of applications, for example, within an automotive generator.

In summary, the present invention dispenses with welding which might otherwise cause damage or partial deformation to a stator ring or result in imprecise alignment of a plurality of plates with each other, spares an intricate riveting procedure which involves forming a plurality of through holes in each of the plates one by one, and avoids the through hole-induced deterioration of the overall quality of the finished products. The present invention entails insulating each of the stator ring elements before pressure laminating the stator ring elements to form the stator ring to thereby prevent an eddy current from being generated in the presence of a varying magnetic field, reduce an eddy current loss, and enhance the performance of an electric generator.

The foregoing embodiments are provided to illustrate and disclose the technical principles and features of the present invention so as to enable persons skilled in the art to understand the disclosure of the present invention and implement the present invention accordingly, and are not intended to be restrictive of the scope of the present invention. Hence, all equivalent modifications and variations made to the foregoing embodiments without departing from the spirit and principles in the disclosure of the present invention should fall within the scope of the invention as set forth in the appended claims.

What is claimed is:

1. A method of manufacturing a stator ring, the method comprising:
(i) forming a plurality of stator ring elements;
(ii) electrically insulating each stator ring element to form a plurality of electrically-insulated stator ring elements; and
(iii) pressure laminating the plurality of electrically-insulated stator ring elements together to form a multi-layer stator ring.

2. The method of claim 1, wherein (i) comprises forming T-shaped talons on an inner radius of each stator ring element.

3. The method of claim 1, wherein (ii) comprises coating each stator ring element with an electrically-insulating varnish by electro-deposition coating.

4. The method of claim 1, wherein (ii) comprises coating an adhesive with electrically-insulating properties on each of the stator ring elements.

5. The method of claim 1, wherein (iii) comprises:
stacking the plurality of electrically-insulated stator ring elements onto a pressure jig; and
implementing the pressure jig to exert vertical and centripetal forces on the electrically-insulated stator ring elements to pressure laminate the insulated stator ring elements together.

6. The method of claim 1, wherein (iii) excludes riveting the stator ring elements together, or welding the stator ring elements together.

7. A pressure-laminated stator ring, comprising:
a plurality of electrically-insulated stator ring elements, wherein said plurality of electrically-insulated stator elements are pressured-laminated together to form a multi-layered stator ring.

8. The pressure-laminated stator ring of claim 8, wherein each of the electrically-insulated stator ring elements comprises an inner rim from which a plurality of T-shaped talons extend therefrom.

9. The pressure-laminated stator ring of claim 7, wherein the plurality of electrically-insulated stator ring elements are coated with an electrically-insulating varnish.

10. The pressure-laminated stator ring of claim 7, wherein the plurality of electrically-insulated stator ring elements are coated with an electrically-insulating adhesive.

11. The pressure-laminated stator ring of claim 7, wherein the pressure-laminated stator ring excludes rivets and welds.

12. A pressure-laminated stator ring manufactured according to the processes comprising:
(i) forming a plurality of stator ring elements;
(ii) electrically insulating each stator ring element to form a plurality of electrically-insulated stator ring elements;
(iii) pressure laminating the plurality of electrically-insulated stator ring elements together.

13. The pressure-laminated stator ring manufactured according to the processes of claim 12, wherein (i) comprises forming T-shaped talons on an inner radius of each stator ring element.

14. The pressure-laminated stator ring manufactured according to the processes of claim 12, wherein (ii) comprises coating each stator ring element with an electrically-insulating varnish by electro-deposition coating.

15. The pressure-laminated stator ring manufactured according to the processes of claim 12, wherein (ii) comprises coating an adhesive with electrically-insulating properties on each of the stator ring elements.

16. The pressure-laminated stator ring manufactured according to the processes of claim 12, wherein (iii) comprises:
stacking the plurality of electrically-insulated stator ring elements onto a pressure jig; and
implementing the pressure jig to exert vertical and centripetal forces on the electrically-insulated stator ring elements to pressure laminate the insulated stator ring elements together.

17. The pressure-laminated stator ring manufactured according to the processes of claim 12, wherein (iii) excludes riveting the stator ring elements together or welding the stator ring elements together.

18. An automotive generator including a stator ring, the stator ring comprising:
a plurality of electrically-insulated stator ring elements,
wherein the plurality of electrically-insulated stator elements are pressured-laminated together to form a multi-layered stator ring.

19. The automotive generator of claim 18, wherein each of the electrically-insulated stator ring elements comprises an inner rim from which a plurality of T-shaped talons extend therefrom.

20. The automotive generator of claim 18, wherein the pressure-laminated stator ring excludes rivets and welds.
